(19) United States
(12) Patent Application Publication
(10) Pub. No.: US 2026/0158923 A1
(43) Pub. Date: Jun. 11, 2026

(54) METHOD FOR OPERATING A MOTOR VEHICLE, AND A MOTOR VEHICLE

(71) Applicant: Dr. Ing. h.c. F. Porsche Aktiengesellschaft, Stuttgart (DE)

(72) Inventors: Stefan WEISS, Leonberg (DE); Matthias KOCH, Rotenburg (Wümme) (DE); Christian BROZICEK, Heilbronn (DE)

(21) Appl. No.: 19/177,670

(22) Filed: Apr. 14, 2025

(30) Foreign Application Priority Data
Apr. 17, 2024 (DE) 10 2024 110 816.9

(51) Int. Cl. B60L 3/00; B60L 58/26; G07C 5/08

(52) U.S. Cl. CPC B60L 3/0046; B60L 58/26; G07C 5/0808; G07C 5/0816; G07C 5/085

(57) ABSTRACT

A method for operating a motor vehicle, wherein the motor vehicle includes a cooling circuit having a first partial circuit and a second partial circuit. The first partial circuit includes an air conditioning compressor and a chiller. The second partial circuit is connected to the first partial circuit via a shut-off valve. The method includes, when the shut-off valve is closed, checking the tightness of the shut-off valve based on a thermal output of the chiller and an electrical output of the air conditioning compressor.

### CROSS REFERENCE TO RELATED APPLICATIONS

This application claims benefit to German Patent Application No. DE 10 2024 110 816.9, filed on Apr. 17, 2024, which is hereby incorporated by reference herein.

### FIELD

The present disclosure relates to a method for operating a motor vehicle having a cooling circuit and to a motor vehicle having a first partial circuit.

### BACKGROUND

Modern motor vehicles have a variety of components that require active cooling. In the case of high-performance electric vehicles in particular, the cooling of the HV components is essentially important. This results in waste heat on the traction battery, on the output electronics, and on the electrical machines, which must absolutely be dissipated in order to avoid damage to these components.

In addition to cooling, which is necessary for a functioning of the driving operation, a climate control of the cabin of the motor vehicle is typically provided. In general, fresh air and/or recirculated air is cooled for this purpose, at least in the summer months.

The different needs for cooling the motor vehicle have very different specifications for the cooling capacity. Thus, a significantly higher cooling capacity is typically required for the cooling of the HV components than for the air conditioning of the cabin.

Despite the differences in the cooling capacity requirements, only a few, preferably only one, air conditioning compressor(s) of the motor vehicle is provided, for reasons of space efficiency, cost savings, and reduced weight. The air conditioning compressor drives several, for example two, partial circuits of the cooling circuit. To meet the different cooling capacity specifications, it is possible to isolate one of the partial circuits with a shut-off valve as needed.

Such a shut-off valve is difficult to monitor. Malfunctions of the shut-off valve often occur, which are not directly detected. This can lead to excessively high cooling capacities in one of the partial circuits.

### SUMMARY

In an embodiment, the present disclosure provides a method for operating a motor vehicle, wherein the motor vehicle comprises a cooling circuit having a first partial circuit and a second partial circuit. The first partial circuit comprises an air conditioning compressor and a chiller. The second partial circuit is connected to the first partial circuit via a shut-off valve. The method comprises, when the shut-off valve is closed, checking the tightness of the shut-off valve based on a thermal output of the chiller and an electrical output of the air conditioning compressor.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically illustrates a detail of a motor vehicle according to an exemplary embodiment of the present disclosure for carrying out a method according to an exemplary embodiment of the present disclosure; and

FIG. 2 schematically illustrates a motor vehicle according to an exemplary embodiment of the present disclosure.

### DETAILED DESCRIPTION

In an embodiment, the present disclosure provides a method for operating a motor vehicle, as well as a motor vehicle, that do not have the aforementioned disadvantages arising from the prior art, but instead allow detection of malfunctions of the shut-off valve.

In the method according to an embodiment of the present disclosure for operating a motor vehicle, the motor vehicle comprises a first partial circuit having an air conditioning compressor and a chiller. The motor vehicle further comprises a second partial circuit. The second partial circuit is connected to the first partial circuit via a shut-off valve. According to the present disclosure, it is provided that, when the shut-off valve is closed, the tightness of the shut-off valve is checked based on a thermal output of the chiller and an electrical output of the air conditioning compressor. As a result, it is advantageously possible to infer the state of the shut-off valve. If a difference arises from the electrical output of the air conditioning compressor and the thermal output of the chiller, it can be assumed that thermal output is removed via the actually closed shut-off valve in the second partial circuit. In other words, a balance of the electrical output of the air conditioning compressor and the thermal output of the chiller is drawn up, and it is checked whether it is equalized. If the balance is not equalized, an unwanted cold sink is considered present in the system.

Preferably, it is provided that the motor vehicle is an electric vehicle, for example a hybrid vehicle or a purely electrically operated motor vehicle.

According to an embodiment of the present disclosure, it is contemplated that an operating point-dependent metric of the first partial circuit is taken into account for checking the tightness. It is thus advantageously possible to take into account system-specific deviations and particularities, depending on the situation. In particular, for example, an output difference by loss dissipation can be considered.

The thermal output of the chiller added to the thermal output falling on the second partial circuit is equal to the metric multiplied by the electrical output of the air conditioning compressor. When the shut-off valve is closed and tight, the thermal output of the second partial circuit is zero. Thus, with the shut-off valve closed and tight, the electrical output of the air conditioning compressor is equal to the thermal output of the chiller divided by the operating point-dependent metric. This monitoring equation is used in order to check the tightness of the shut-off valve. If the monitoring equation is satisfied, the closed shut-off valve is tight. If the monitoring equation is not met, a leak in the shut-off valve can be inferred.

The metric can depend on a coolant pressure and/or an external temperature and/or a coolant temperature in the forward flow and/or a coolant temperature in the return flow.

According to an embodiment of the present disclosure, the method is only executed during stationary operation of the air conditioning compressor. This advantageously ensures that the checking of the tightness of the shut-off valve is not falsified by fluctuations in the electrical performance of the air conditioning compressor. Such fluctuations of the electrical output typically occur during non-stationary operation of the air conditioning compressor, that is to say, in cases where the electrical output of the air conditioning compressor is increased or decreased.

Preferably, the method is carried out only after a waiting period following the start of the air conditioning compressor. Particularly during the startup phase of the air conditioning compressor, it is expected that the electrical output of the air conditioning compressor will not be fully converted into thermal output at the chiller. On the one hand, the losses in the air conditioning compressor are higher during startup than in stationary operation. On the other hand, there are additional losses in the system, for example, due to cooling of the piping and other components of the first partial circuit. The waiting period advantageously prevents the aforementioned losses from distorting the check of the shut-off valve's tightness during the air conditioning compressor's startup.

According to an embodiment of the present disclosure, the chiller operates a secondary circuit for cooling HV components of the motor vehicle. This advantageously allows cooling-intensive components, such as HV components, to be effectively cooled, while components of the motor vehicle that require less cooling output can be supplied with individually coordinated cooling output in the second partial circuit by the shut-off valve. HV components of the motor vehicle can include a traction battery, output electronics, and/or electric machines, in particular electric drive machines.

Preferably, the thermal output of the chiller is determined using a first temperature sensor in the forward flow of the secondary circuit and a second temperature sensor in the return flow of the secondary circuit. Determining the thermal output of the chiller by measuring the temperature difference before and after the chiller is a simple and effective method of determining the thermal output.

According to an embodiment of the present disclosure, it is provided that a cabin of the motor vehicle is cooled with the second partial circuit. It is preferably provided that a vaporizer is cooled in the second partial circuit for cooling fresh air and/or recirculated air. As a result, it is advantageously possible for cooling-intensive components, such as the HV components of the motor vehicle, as well as less cooling-intensive components, such as the climate control of the cabin, to be supplied with cooling. The shut-off valve monitored for tightness provides a high level of reliability of the correct cooling supply.

It is further preferably provided that, if a leakage of the shut-off valve is detected, an alert is issued and/or an error code is stored in a memory of the motor vehicle. This can inform a driver of the motor vehicle to head for a garage that can perform the detection of leakage of the shut-off valve without the occurrence of critical situations, such as failure of cooling of the HV components. Furthermore, by indicating the leakage and the timely repair of the leakage caused by this, it is achieved that an amount of electrical output is not unnecessarily converted into cooling output, which saves energy when operating the motor vehicle. Finally, by indicating problems with unwanted cooling performance, irritations can be avoided, which could occur, for example, due to too cold fresh air supply into the cabin.

A further subject-matter for solving the problem mentioned above is a motor vehicle configured so as to carry out the method according to the present disclosure.

According to an embodiment of the present disclosure, it is contemplated that the shut-off valve is configured as an analog valve, preferably without direct feedback of the layout position. The use of such a valve is cost-effective. Analog valves without complex technology are typically very robust, lightweight, and require little installation space.

All details, features, and advantages disclosed in connection with the method according to the present disclosure also relate to the motor vehicle according to the present disclosure. Likewise, all details, features, and advantages disclosed in connection with the motor vehicle according to the present disclosure also relate to the method according to the present disclosure.

Further details, features, and advantages of the present disclosure can be found in the drawings as well as from the following description of preferred embodiments based on the drawings. The drawings illustrate only exemplary embodiments, which do not restrict the concept of the present disclosure.

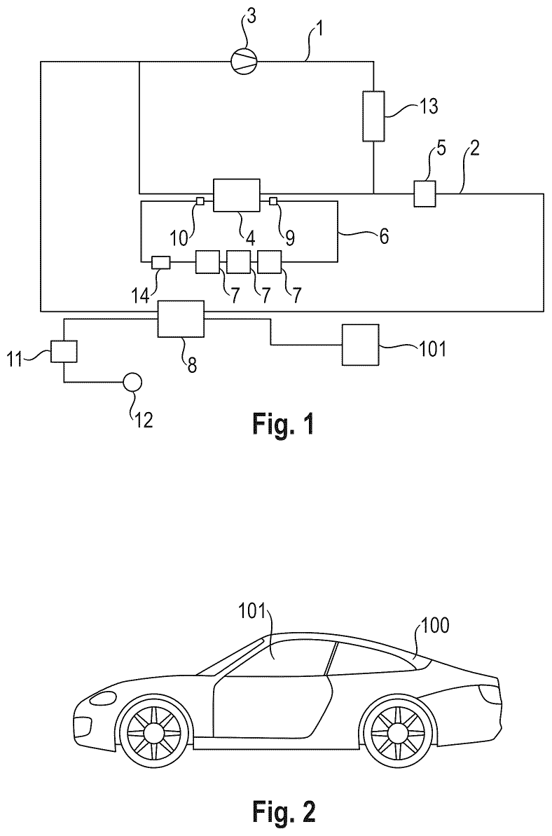

FIG. 1 schematically illustrates a detail of a motor vehicle 100 (see FIG. 2) according to an exemplary embodiment of the present disclosure. The motor vehicle 100 is configured so as to carry out a method according to an exemplary embodiment of the present disclosure, as described below.

The motor vehicle 100 has a first partial circuit 1 with an air conditioning compressor 3 and a condenser 13. With this, a refrigerant is cooled in the first partial circuit 1. The first partial circuit 1 further comprises a chiller 4 having an electrical expansion valve 16, which cools a coolant in a secondary circuit 6. The secondary circuit 6 is provided for cooling HV components 7 of the motor vehicle 100. HV components 7 can include, for example, a traction battery, a power electronics, or an electrical traction machine of the motor vehicle 100. Typically, the HV components 7 require comparatively high cooling performance. To operate the secondary circuit 6, a pump 14 is provided in the secondary circuit 6.

The first partial circuit 1 is further connected to a second partial circuit 2 via a shut-off valve 5. Via the second partial circuit 2, a vaporizer 8, which comprises a thermal expansion valve 17, is supplied with coolant. The vaporizer 8 cools fresh air and/or recirculated air, which is supplied by a fan 11 from a fresh air and/or recirculated air supply 12 via a clearance 15 to air-condition the cabin 101 from the surroundings of the motor vehicle 100 and the cabin 101, respectively, and is conveyed into the cabin 101 of the motor vehicle 100. The cabin 101 is air-conditioned via the vaporizer 8.

Typically, the climate control of the cabin 101 requires significantly less cooling output than the temperature control of the HV components 7 of the motor vehicle 100. If no cooling capacity is needed on the vaporizer 8, then the shut-off valve 5 is closed. In order to save costs, reduce weight, and take up as little construction space as possible, the shut-off valve 5 is designed as an analog valve without direct feedback of a layout position of the shut-off valve 5. It can be problematic in this case that leakages of the shut-off valve 5 are not detected. If the shut-off valve 5 is closed and still allows coolant to pass into the second partial circuit 2, the incoming fresh air or recirculated air is cooled too much. There is an undesirable high energy consumption, and components of the partial circuits 1, 2 are loaded more heavily than necessary.

In order to check the tightness of the shut-off valve 5, when the shut-off valve 5 is closed, the thermal output of the chiller 4 is compared to the electrical output of the air conditioning compressor 3. An operating point-dependent metric of the first partial circuit 1 is taken into account in this context.

The thermal output of the chiller 4 added to the thermal output of the second partial circuit 2 is equal to the metric multiplied by the electrical output of the air conditioning compressor 3. With the shut-off valve 5 closed and tight, the thermal output of the second partial circuit 2 is zero. Thus, with the shut-off valve 5 closed and tight, the electrical output of the air conditioning compressor 3 is equal to the thermal output of the chiller 4 divided by the operating point-dependent metric. If this condition is met, the closed shut-off valve 5 is sealed. If this condition is not met, a leak in the shut-off valve 5 can be inferred.

The thermal performance of the chiller 4 is determined by the difference between a first temperature sensor 9 in the forward flow of the secondary circuit 6 and a second temperature sensor 10 in the return flow of the secondary circuit 6.

To improve the accuracy of determining the tightness of the shut-off valve 5, the method is carried out only when the air conditioning compressor 3 is in a stationary state, in particular after a waiting period following the start of the air conditioning compressor 3.

If a leak in the shut-off valve 5 is detected, this is reported to the driver and/or an error code is stored in a memory of the motor vehicle 100.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 First partial circuit
2 Second partial circuit
3 Air conditioning compressor
4 Chiller
5 Shut-off valve
6 Secondary circuit
7 HV component
8 Vaporizer
9 First temperature sensor
10 Second temperature sensor
11 Fan
12 Fresh air and/or recirculating air supply
13 Capacitor
14 Pump
15 Clearance for air conditioning of the cabin
16 Electrical expansion valve
17 Thermal expansion valve
100 Motor vehicle
101 Cabin

1. A method for operating a motor vehicle, wherein the motor vehicle comprises a cooling circuit having a first partial circuit and a second partial circuit, wherein the first partial circuit comprises an air conditioning compressor and a chiller, and wherein the second partial circuit is connected to the first partial circuit via a shut-off valve, the method comprising, based on closing the shut-off valve, checking the tightness of the shut-off valve based on a thermal output of the chiller and an electrical output of the air conditioning compressor.

2. The method according to claim 1, wherein an operating point-dependent metric of the first partial circuit is taken into account in the checking of the tightness.

3. The method according to claim 1, wherein the method is only carried out in a stationary operation of the air conditioning compressor.

4. The method according to claim 3, wherein the checking of the tightness of the shut-off valve is carried out only after a waiting period after a start of the air conditioning compressor.

5. The method according to claim 1, comprising operating a secondary circuit for cooling HV components of the motor vehicle with the chiller.

6. The method according to claim 5, comprising determining the thermal output of the chiller by a first temperature sensor in a forward flow of the secondary circuit and a second temperature sensor in a return flow of the secondary circuit.

7. The method according to claim 1, comprising cooling a cabin of the motor vehicle with the second partial circuit.

8. The method according to claim 1, comprising, if a leakage of the shut-off valve is detected, issuing an alert and/or storing an error code in a memory of the motor vehicle.

9. A motor vehicle configured to carry out the method according to claim 1.

10. The motor vehicle according to claim 9, wherein the shut-off valve is configured as an analog valve.

11. The method according to claim 7, wherein a vaporizer is cooled for cooling fresh air and/or recirculated air in the second partial circuit.

12. The motor vehicle according to claim 10, wherein the shut-off valve is configured without a direct feedback of a layout position.
